(19) United States
(12) Patent Application Publication
(10) Pub. No.: US 2006/0044394 A1
(43) Pub. Date: Mar. 2, 2006

(54) Method and apparatus for a computer controlled digital camera

(75) Inventor: Christopher Jensen Read, San Diego, CA (US)

Correspondence Address: FITCH EVEN TABIN & FLANNERY, 120 SOUTH LASALLE SUITE 1600, CHICAGO, IL, 60603, US

(73) Assignees: Sony Corporation, Shinagawa-Ku (JP); Sony Electronics Inc., Park Ridge, NJ (US)

(21) Appl. No.: 10/925,637

(22) Filed: Aug. 24, 2004

(51) Int. Cl. H04N 5/225; H04N 5/232; H04N 5/76

(52) U.S. Cl. 348/207.1; 348/207.11; 348/211.99; 348/231.99

(57) ABSTRACT

In one embodiment a method and apparatus is provided for a digital camera controlled by a remote computer. The remote computer commands the digital camera as to when to take pictures, how long to pause before taking subsequent pictures, and when to stop taking pictures. The digital camera senses current photographic conditions, which are later requested by the remote computer. Based upon the digital camera's current photographic conditions, the remote computer calculates the appropriate exposure parameters for the digital camera and commands the digital camera to set its exposure parameters accordingly. After a picture is taken, the picture is stored as image data in volatile memory in the digital camera. The image data is then transferred to the remote computer for compression and storage in the remote computer's non-volatile memory. The remote computer subsequently encodes the stored image data into a time-lapse video file.

### BACKGROUND OF THE INVENTION

1. Field of the Invention

The present invention relates to digital cameras. More specifically, the present invention relates to computer controlled digital cameras.

2. Discussion of the Related Art

Digital cameras today have the ability to take pictures with resolutions as high as five mega-pixels. The storage capacity in digital cameras, however, remains limited, such that your standard digital camera has sufficient space to store only a few high-resolution pictures at any one time.

While high resolution video cameras currently exist that have high storage capacities, such cameras are prohibitively expensive to the average consumer. Affordable video cameras that record for lengthy periods of time typically record with low quality and with low resolution.

### SUMMARY OF THE INVENTION

The different embodiments described herein address the above mentioned needs as well as other needs by providing a method and apparatus for a computer-controlled digital camera with the capability of remotely storing high volumes of image data.

One embodiment can be characterized as a method comprising coupling a digital camera to a controlling device; receiving a command to take a picture from the controlling device at the digital camera; and taking the picture with the digital camera in response receiving the command to take the picture.

Another embodiment can be characterized as a method comprising coupling a digital camera to a controlling device; taking a picture with the digital camera; storing the picture as image data on a volatile memory device in the digital camera; and transmitting the image data from the volatile memory device on the digital camera to a non-volatile memory device on the controlling device.

Yet another embodiment can be characterized as a method comprising coupling a digital camera to a controlling device; sending a signal from the controlling device to the digital camera requesting the current photographic environment; and sending a command from the controlling device to the digital camera which sets exposure parameters on the digital camera.

A subsequent embodiment includes an apparatus comprising a controlling device comprising memory; a digital camera coupled to the controlling device comprising non-volatile memory, wherein the digital camera takes pictures comprising image data at specified intervals; and wherein the image data is stored in the memory of the controlling device without first being stored in the non-volatile memory of the digital camera.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a perspective diagram illustrating a laptop computer connected to a digital camera in accordance with one embodiment;

FIG. 2 is a block diagram illustrating a computer connected to a digital camera in accordance with another embodiment;

FIG. 3 is a flow diagram illustrating a method of taking pictures with a computer controlled digital camera in accordance with one embodiment;

FIG. 4 is a flow diagram illustrating a method of storing image data in volatile memory of a digital camera into non-volatile memory of a controlling device in accordance with another embodiment;

FIG. 5 is a flow diagram illustrating a method of using a computer to set exposure parameters on a digital camera in accordance with yet another embodiment.

### DETAILED DESCRIPTION

The following description is not to be taken in the limiting sense, but is made merely for the purpose of describing the general principles of the invention. The scope of the invention should be determined with reference to the claims.

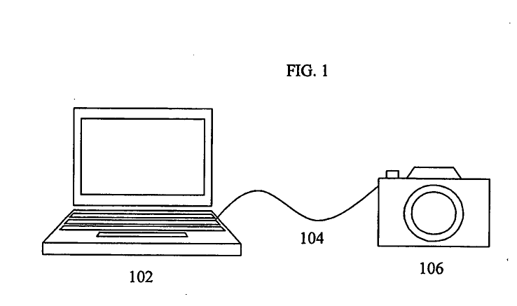

Referring to FIG. 1, a perspective diagram is shown illustrating a laptop computer connected to a digital camera in accordance with one embodiment. Shown are the laptop computer 102, a connector cable 104, and the digital camera 106. The digital camera 106.is connected to the laptop computer 102 by the connector cable 104.

The description above has been made with reference to the connector cable 104. The connector cable 104 is a USB or fire-wire cable, a combination thereof, or another cable or combination of cables in accordance with a preferred embodiment. Alternatively, wireless communication devices, adapters, interfaces, ports, or pin connectors replace the connector cable 104. For example, in one embodiment, the laptop computer 102 and the digital camera 106 each have antennas and exchange data wirelessly over a radio frequency.

Though the above description has been made with reference to a laptop computer 102, many controlling devices are readily substitutable. This includes, for example, desktop computers, personal digital assistants and many other such devices.

Software on the laptop computer 102 sends commands via the connector cable 104 to the digital camera 106, which the digital camera 106 receives and interprets. These commands include, for example, commands for taking a picture or a series of pictures at specified times, pausing for specified time intervals before taking successive pictures, and adjusting exposure parameters such as aperture, shutter speed, f-stop, depth of field on the digital camera 106, and flash settings. In one embodiment, the laptop computer 102 requests the digital camera's 106 current photographic environment via the connector cable 104. After the request is fulfilled, the laptop computer 102 uses the digital camera's 106 current photographic environment to calculate the appropriate exposure parameters that the digital camera 106 will use in taking a picture. The digital camera 106 receives the exposure parameters from the laptop computer 102 via the connector cable 104 and adjusts the exposure parameters accordingly.

In one exemplary embodiment, the laptop computer 102 overrides the digital camera's 106 automatic exposure adjustment by sending commands to the digital camera 106 that set exposure parameters. The digital camera's 106 automatic exposure adjustment brightens a picture taken in cloudy or dark conditions, darkens a picture taken in sunny or bright conditions, and changes depth of field, making certain subjects move in and out of focus as the digital camera 106 opens and closes its iris. The digital camera's 106 automatic exposure adjustment will normally be activated when photographic conditions change relative to the photographic conditions corresponding to the digital camera's 106 most recent exposure settings. For time-lapse photography and video (i.e. taking pictures of the same subject at regular intervals, storing each picture as a sequence of image data, and encoding each sequence of image data as a single frame or series of frames in a target video), the digital camera's 106 automatic exposure adjustment will often produce a frame or series of frames which is relatively much darker or much lighter than the other frames in the video.

For example, the laptop computer 102 and digital camera 106 are set up to take a picture of a beach scene every ten minutes. While the beach remains sunny, each picture taken by the digital camera 106 will be taken at exposure settings similar to the exposure settings used by the digital camera 106 for the previous pictures. However, when a cloud envelops the sun for ten minutes, the digital camera's 106 automatic exposure adjustment attempts to compensate for the dark scene by adding brightness to that particular picture. The picture taken when the cloud enveloped the sun will not possess the same degree of brightness as compared to the pictures taken when the scene was sunny. When viewed as a time-lapse video, the frame that is yielded by the sequence of image data corresponding to the cloudy scene at the beach looks unusual or incongruous relative to the other frames in the video.

To solve this problem, the laptop computer 102 at successive intervals of time sends a request to the digital camera 106 for the digital camera's 106 current photographic environment. The laptop computer 102 uses the current and previous photographic environments of the digital camera 106 to calculate appropriate exposure parameters for the digital camera's 106 next picture. Next, the laptop computer 102 sends a command to the digital camera 106 via the connector cable 104 to set the digital camera's 106 exposure parameters accordingly. The laptop computer 102 thus prevents the digital camera from adjusting its exposure parameters too rapidly between successive pictures. This in turn produces time-lapse video without the disparity in brightness between frames.

The laptop computer 102, in one embodiment, also sends a command to the digital camera 106 to control a flash setting on the digital camera 106. For example, the laptop computer can send a command that causes the flash to fire. The command can also include an intensity setting for the flash. Controlling the flash can make a single image have a more uniform brightness and can also be used to achieve a uniform brightness from one picture to another during a time-lapse sequence.

Additionally, the digital camera's 106 automatic exposure adjustment often changes depth of field, making certain subjects move in and out of focus as photographic conditions change. For example, if the automatic exposure adjustment of the digital camera commands the digital camera 106 to open the digital camera's 106 iris in response to a cloud enveloping the sun, certain subjects in the picture will not possess the same degree of sharpness as compared to the same subjects when seen in previous pictures. When viewed as a time-lapse video, the frame that is yielded by the sequence of image data corresponding to the cloudy scene looks unusual or incongruous relative to the other frames in the video.

To solve this problem, the laptop computer 102 at successive intervals of time sends a request to the digital camera 106 for the digital camera's 106 current photographic environment. The laptop computer 102 uses the current and previous photographic environments of the digital camera 106 to calculate appropriate exposure parameters for the digital camera's 106 next picture. Next, the laptop computer 102 sends a command to the digital camera 106 via the connector cable 104 to set the digital camera's 106 exposure parameters accordingly. The laptop computer 102 thus prevents the digital camera from opening the digital camera's 106 iris too rapidly between successive pictures. This in turn produces time-lapse video without the disparity in sharpness between the same subject as seen through successive frames.

Conventional digital cameras often have insufficient space to store video files, particularly high-definition video files, which typically require massive amounts of storage space. Because of these memory constraints, a user is typically relegated to recording videos in standard or low resolutions, which have noticeably poorer video quality, but require less space.

In a preferred embodiment, the digital camera 106 stores high-resolution pictures as image data directly to a mass storage device in the laptop computer 102. This allows the user to subsequently create high definition video files from the high-resolution pictures taken from the digital camera 106.

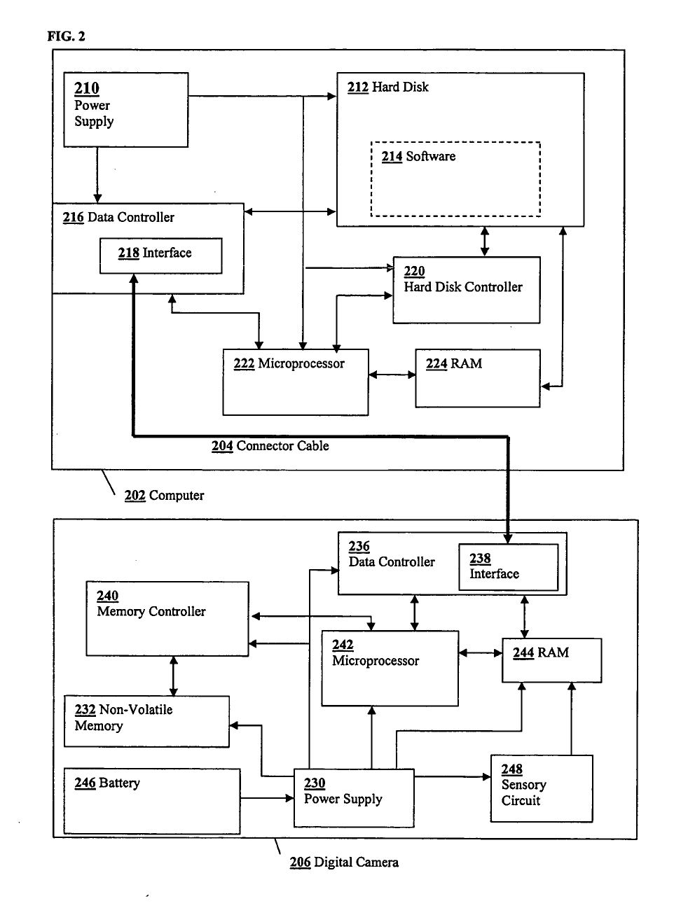

Referring to FIG. 2, a block diagram is shown illustrating a computer 202 connected to a digital camera 206 by a connector cable 204 in accordance with another embodiment. The computer 202 includes a power supply 210, a data controller 216, a data controller interface 218, a microprocessor 222, software 214 resident on a hard disk 212, a hard disk controller 220, and random access memory (RAM) 224. The digital camera 206 includes a data controller 236, a data controller interface 238, a memory controller 240, a microprocessor 242, RAM 244, non-volatile memory 232, a battery 246, a power supply 230, and a sensory circuit 248. The connector cable 204 connects at one end with the data controller interface 218, and at the other end with the data controller interface 238.

Referring first to the computer 202, the power supply 210 is electrically coupled to the hard disk 212, the data controller 216, the microprocessor 222, the RAM 224, and the hard disk controller 220. The data controller 218, the hard disk controller 220, and the RAM 224 are electrically coupled to the microprocessor 222. The hard disk 212 is electrically coupled to the hard disk controller 220 and the data controller 216. The data controller interface 218 is electrically coupled to the data controller 218.

Referring next to the digital camera 206, the power supply 230 is electrically coupled to the non-volatile memory 232, the sensory circuit 248, the microprocessor 242, the data controller 236, the memory controller 240, and the RAM 244. The memory controller 240, the data controller 236, and the RAM 244 are electrically coupled to the microprocessor 242. The sensory circuit 248 and the data controller 236 are electrically coupled to the RAM 244. The data controller interface 238 is electrically coupled to the data controller 236, the non-volatile memory 232 is electrically coupled to the memory controller 240, and the battery 246 is electrically coupled to the power supply 230.

Referring again to the computer 202, the power supply 210 provides power to the hard disk 212, the data controller 216, the microprocessor 222, the hard disk controller 220, and the RAM 224. The hard disk 212 is a non-volatile storage medium for data. Streams of image data transmitted from the digital camera 206 via the connector cable 204 are received at the data controller 216 and subsequently stored on available space in the hard disk 212. The microprocessor 222 controls the central processing of data in the computer 202. The hard disk controller 220 manages the transmission of data to and from the hard disk 212. The RAM 224 is a volatile memory device used by the microprocessor for quickly accessing data.

The software 214 resident on the hard disk 212 performs many functions. These functions include requesting the current photographic environment of the digital camera 206, computing the appropriate exposure parameters for the digital camera's 206 next picture, sending the appropriate exposure parameters to the digital camera 206, creating image files from transmitted streams of image data, creating a video file from a series of image files, providing an interface that allows the user to browse directories and view image files, and sending commands to the digital camera 206 specifying when to begin taking pictures, how long to pause before taking another picture, and when to stop taking pictures.

In one exemplary embodiment, the software 214 resident on the hard disk 212 converts the streams of image data into compressed image files using a conversion routine such as Joint Photographic Experts Group (JPEG) compression. The compressed image files advantageously require less storage space on the hard disk 212. Optionally, the software 214 provides an interface which allows the user to browse directories and view image files. This allows the user to see the pictures taken on the digital camera 206 on a display screen of the computer 204.

In another exemplary embodiment, the user creates a video file based on customizable settings. Upon running software 214, the user is requested to input a number of settings related to video creation and playback. These settings include, for example, source files (e.g., a series of pictures taken with the digital camera 106 during a time-lapse photography session), target file type, target file size, target frame rate, and target resolution. After receiving the user's input, the software 214 encodes the source files into frames of a compressed video file using an algorithm such as Motion Picture Experts Group (MPEG) compression. Alternatively, the user creates the video file using default settings directly provided by the software 214. In one embodiment, the default settings are generated from system information provided by the computer 202. In another embodiment, default settings are provided by data included in the software 214.

Referring again to the digital camera 206, the power supply 230 draws power from the battery 246 and provides power to the non-volatile memory 232, the data controller 236, the microprocessor 242, the memory controller 240, the sensory circuit 248, and the RAM 244. The non-volatile memory 212 is a non-volatile storage medium for data, such as a hard disk, a flash-memory device, a memory stick, or many other such type devices. The memory controller 240 manages the transmission of data to and from the non-volatile memory 232. The sensory circuit 248 senses changes in photographic conditions, such as changes in lighting, motion, and brightness. The microprocessor 242 controls the central processing of data in the digital camera 206. The RAM 224 is a volatile memory device used by the microprocessor for quickly accessing data and for temporarily storing image data before the image data is transferred to, for example, the non-volatile memory 232 of the digital camera 202 or the hard disk 212 of the computer 202.

The data controller 236 facilitates a variety of tasks, including: sending to the computer 202 streams of image data stored in the RAM 244 or the non-volatile memory 232, providing the computer 202 with the current photographic environment of the digital camera 206, and receiving from the computer 202 commands to take a picture, commands to pause for a specified interval before taking the next picture, and commands to set the digital camera's 206 exposure parameters to those parameters provided by the computer 202.

In one exemplary embodiment, the digital camera 206 takes a series of high resolution pictures. After a picture is taken, the picture is stored as image data in the RAM 244. The image data is subsequently transferred from the RAM 244 to the computer 202 to be compressed and stored in the hard disk 212 of the computer 202. Advantageously, this allows the user to store a large number of high-resolution pictures in the computer's 202 memory independent of the capacity of the digital camera 206 to store high-resolution pictures in the digital camera's 206 non-volatile memory 232.

In another exemplary embodiment, software 214 on the computer 202 creates a high definition video based upon a series of high-resolution pictures taken by the digital camera 206. The high-resolution pictures are 1920 pixels by 1080 in one exemplary embodiment. After the digital camera 206 takes a picture, the picture is stored as image data in the RAM 244. The image data is subsequently transferred from the RAM 244 to the computer 202 to be compressed and stored as a series of image files in the computer's hard disk 212. The software 214 encodes the series of image files into frames of a compressed video file using an algorithm such as Motion Picture Experts Group (MPEG) compression. The user specifies requested fields from the software 214 related to video creation and playback, such as desired file type, file size, frame rate, and resolution. Advantageously, this allows the user to create time-lapse high definition video from the series of pictures taken by the digital camera whenever the digital camera 206 has insufficient space to store the video in the digital camera's 206 non-volatile memory 232.

In another exemplary embodiment, the computer 202 sends commands to the digital camera 206 as to when to begin taking pictures, how long to pause before taking another picture, and when to stop taking pictures. The user specifies to the software 214 parameters such as a start time, a total number of pictures to be taken, and an interval to pause between pictures. For example, a user requests the software 214 to begin taking pictures at 10:00 pm, to take a total of 1000 pictures, and to pause 30 seconds between taking each picture. Optionally, an end-time replaces the total number of pictures to be taken. This allows the user to take pictures with the digital camera 206 without requiring the user to be present while the pictures are being taken.

Alternatively, the standard shutter-release button on the digital camera 206 commands the digital camera 206 to take the next picture in the series. This technique is used, for example, in animation, thus providing the user with sufficient time to align the subject properly before taking the next picture. The computer 202 continues to control the exposure parameters in this embodiment.

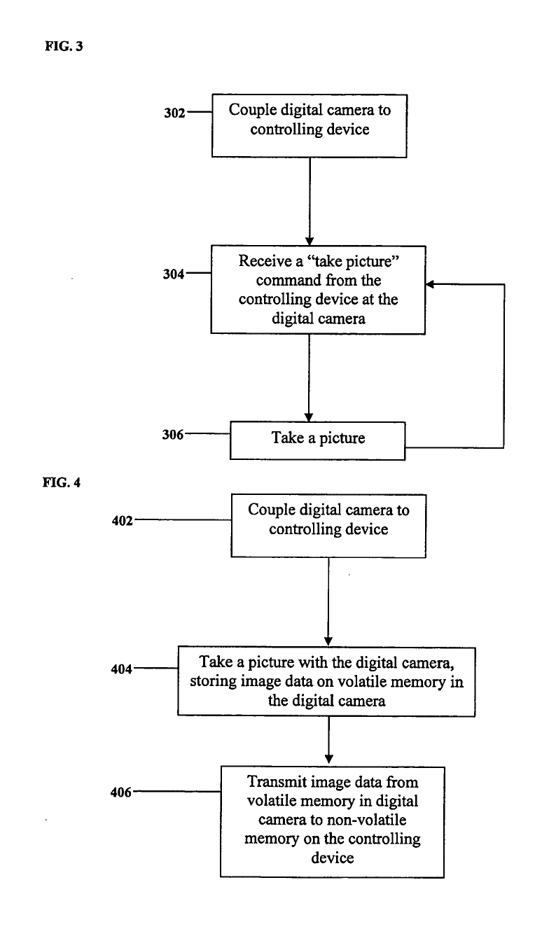

Referring to FIG. 3, a flow diagram is shown illustrating a method of taking pictures with a computer-controlled digital camera in accordance with one embodiment.

In step 302, the digital camera is electrically coupled to the controlling device. The controlling device is a device such as a laptop computer, a desktop computer, a personal digital assistant, a tablet personal computer, or many other devices. In one embodiment, the electrical coupling of the controlling device to the digital camera is accomplished by connecting a cable such as a USB or fire-wire cable, a combination thereof, or another cable or combination of cables between the controlling device and the digital camera. Wireless communication devices, adapters, interfaces, ports, or pin connectors replace the connector cable in other embodiments. For example, in one embodiment, the controlling device and the digital camera each have antennas and exchange data wirelessly over a radio frequency.

In step 304, the controlling device sends a command to the digital camera to begin taking a set of pictures. In a preferred embodiment, the user specifies to the controlling device parameters such as when to begin taking the set of pictures, how long to pause before taking the next picture in the set, and the total number of pictures in the set. Optionally, an end-time replaces the total number of pictures in the set. In one embodiment, the controlling device sends a single command to the digital camera containing all of the above parameters. In another embodiment, the controlling device sends one command or a set of commands for each picture in the set. The controlling device pauses for the specified time before issuing the next command, and terminates issuing commands after all pictures in the set have been taken.

In step 306, the digital camera takes the picture. If there are additional pictures in the set to be taken, the camera pauses before taking the next picture for an amount of time equal to the time specified by the command issued by the controlling device. In an alternative embodiment, the digital camera takes one picture per each command or set of commands received from the controlling device.

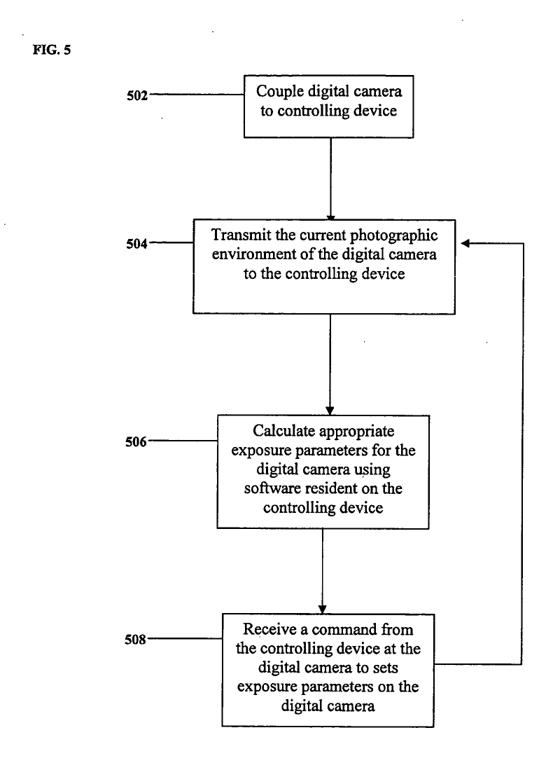

Referring to FIG. 4, a flow diagram is shown illustrating a method of storing image data in volatile memory of a digital camera into non-volatile memory of a controlling device in accordance with another embodiment.

In step 402, the digital camera is coupled to the controlling device.

In step 404, a picture is taken. The picture is stored as image data in the volatile memory of the digital camera, such as RAM. In one embodiment, the image data in the volatile memory of the digital camera is stored as a discrete image file. In another embodiment, the image data is appended to a block of image data. Reference indicators mark the image data corresponding to each particular picture stored within the block.

In step 406, the image data stored in the volatile memory of the digital camera is transmitted to the non-volatile memory of the controlling device. The non-volatile memory of the controlling device is a device such as a hard disk, a flash-memory device, a memory stick, or many other such type devices. In one embodiment, the controlling device compresses the image data before the image data is stored in the non-volatile memory. Compression is performed by a conversion routine such as Joint Photographic Experts Group (JPEG) compression. In another embodiment, the image data is stored in the non-volatile memory of the controlling device in an uncompressed format. Alternatively, the image data stored in the volatile memory of the digital camera is compressed before being transmitted to the non-volatile memory of the controlling device.

In one exemplary embodiment, the digital camera takes a series of high-resolution pictures. After a picture is taken, the picture is stored as image data in the RAM of the digital camera. The image data is subsequently transferred from the RAM of the digital camera to the computer's hard disk. Advantageously, this allows a user to store the series of high-resolution pictures in the computer's hard disk regardless of the storage capability of the digital camera.

Referring to FIG. 5, a flow diagram is shown illustrating a method of using a computer to set exposure parameters on a digital camera in accordance with another embodiment.

In step 502, the digital camera is coupled to the controlling device.

In step 504, the controlling device receives information relating to the digital camera's current photographic environment. In one embodiment, the information includes parameters that the digital camera expects to use in taking the next picture. In another embodiment, the information includes sensory data from the digital camera, such as an amount of light, motion, or brightness that the digital camera senses in the current photographic environment.

In step 506, the controlling device calculates appropriate exposure parameters for the digital camera's next picture. In one embodiment, the controlling device compares the digital camera's expected exposure settings for the next picture with the exposure settings used by the digital camera in previous pictures. Software running on the controlling device adjusts the exposure parameters provided if the comparison yields a difference exceeding a specified threshold. The threshold is provided by data within the software. Alternatively, the user provides the threshold through input to the software. In another embodiment, the controlling device calculates appropriate exposure parameters for the digital camera based on sensory data it requests from the digital camera. Software resident on the controlling device performs the calculation.

In step 508, the controlling device sends a command to the digital camera containing exposure parameters. In one embodiment, such commands are received by the digital camera at successive intervals of time. In another embodiment, a single command or set of commands is transmitted containing data such as the maximum allowable amount of change in exposure parameters between each successive picture. The digital camera then adjusts its exposure parameters accordingly.

In one exemplary embodiment, a computer coupled to a digital camera by a connector cable, overrides the digital camera's automatic exposure adjustment such as described above herein.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

1. A method comprising:
coupling a digital camera to a controlling device;
receiving a command to take a picture at the digital camera; and
taking the picture with the digital camera in response receiving the command to take the picture.

2. The method of claim 1 further comprising the steps of:
storing the picture as image data on a volatile memory device in the digital camera; and
transmitting the image data from the volatile memory device on the digital camera to a non-volatile memory device on the controlling device.

3. The method of claim 1 further comprising the steps of:
transmitting the current photographic environment of the digital camera to the controlling device; and
receiving a command from the controlling device at the digital camera that sets exposure parameters on the digital camera.

4. The method of claim 3 further comprising the step of providing the controlling device with a requested set of exposure parameters.

5. The method of claim 1 further comprising the steps of:
storing the picture as image data on a volatile memory device in the digital camera;
transmitting the image data from the volatile memory device on the digital camera to a non-volatile memory device on the controlling device;
transmitting the current photographic environment of the digital camera to the controlling device; and
receiving a command from the controlling device at the digital camera that sets exposure parameters on the digital camera.

6. The method of claim 5 further comprising the step of providing the controlling device with a requested set of exposure parameters.

7. A method comprising:
coupling a digital camera to a controlling device;
taking a picture with the digital camera;
storing the picture as image data on a volatile memory device in the digital camera; and
transmitting the image data from the volatile memory device on the digital camera to a non-volatile memory device on the controlling device.

8. The method of claim 7 further comprising the steps of:
transmitting the current photographic environment of the digital camera to the controlling device; and
receiving a command from the controlling device at the digital camera that sets exposure parameters on the digital camera.

9. The method of claim 8 further comprising the step of providing the controlling device with a requested set of exposure parameters.

10. A method comprising:
coupling a digital camera to a controlling device;
transmitting the current photographic environment of the digital camera to the controlling device; and
receiving a command from the controlling device at the digital camera that sets exposure parameters on the digital camera.

11. The method of claim 10 further comprising the step of providing the controlling device with a requested set of exposure parameters.

12. An apparatus comprising:
a controlling device comprising memory;
a digital camera coupled to the controlling device comprising non-volatile memory, wherein the digital camera takes pictures comprising image data at specified intervals; and
wherein the image data is stored in the memory of the controlling device without first being stored in the non-volatile memory of the digital camera.

13. The apparatus of claim 12 wherein the controlling device further comprises software that encodes the image data stored in the memory of the controlling device into a time-lapse video.

14. The apparatus of claim 12 wherein the controlling device further comprises software that controls exposure parameters of the digital camera.

15. The apparatus of claim 12 wherein the controlling device further comprises software that encodes the image data stored in the memory of the controlling device into a time-lapse video; and wherein the software controls exposure parameters of the digital camera.

16. The apparatus of claim 12 wherein the controlling device further comprises software that controls when the digital camera takes the pictures and the intervals between taking the pictures.

17. The apparatus of claim 12 wherein the controlling device further comprises software that encodes the image data stored in the memory of the controlling device into a time-lapse video; and wherein the software controls when the digital camera takes the pictures and the intervals between taking the pictures.

18. The apparatus of claim 12 wherein the controlling device further comprises software that controls exposure parameters of the digital camera; and wherein the software controls when the digital camera takes the pictures and the intervals between taking the pictures.

19. The apparatus of claim 12 wherein the controlling device further comprises software that encodes the image data stored in the memory of the controlling device into a time-lapse video; wherein the software controls exposure parameters of the digital camera; and wherein the software controls when the digital camera takes pictures and the intervals between taking the pictures.

20. The apparatus of claim 12 wherein the digital camera takes pictures with resolutions at least as great as 2 megapixels.
